(19) United States
(12) Patent Application Publication
(10) Pub. No.: US 2004/0162872 A1
(43) Pub. Date: Aug. 19, 2004

(54) System and method for invoking WebDAV methods via component technologies

(76) Inventors: Richard Friedman, Cherry Hill, NJ (US); Joseph John Snyder, Shamong, NJ (US); Jason A. Kinner, Marlton, NJ (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/368,086

(22) Filed: Feb. 17, 2003

(51) Int. Cl. G06F 15/16

(52) U.S. Cl. 709/203

(57) ABSTRACT

A method for invoking a WebDAV method via a component technology comprises receiving a request for a WebDAV method in a component technology format, and responsive to receiving the request, invoking the requested WebDAV method.

### CROSS-REFERENCE TO RELATED APPLICATIONS

This application is related to concurrently filed and commonly assigned U.S. patent application Ser. No. [Attorney Docket No. 100203180-1], entitled “SYSTEM AND METHOD FOR INVOKING WEBDAV METHODS VIA NON-WEBDAV COMMUNICATION PROTOCOLS”, and concurrently filed and commonly assigned U.S. patent application Ser. No. [Attorney Docket No. 100203182-1], entitled “SYSTEM AND METHOD FOR INVOKING WEBDAV METHODS VIA NON-WEBDAV PROTOCOLS”, the disclosures of which are hereby incorporated herein by reference.

### BACKGROUND

With the proliferation of digital assets, such as web pages, available today, it is often desirable to have a collaborative effort in working with such digital assets. For example, a plurality of World Wide Web (“Web”) developers in geographically distant locations may collaborate on a project. The Web has traditionally not provided a suitable environment for managing such a collaborative effort. More particularly, while the Web has traditionally allowed read access to documents, it has failed to provide suitable management necessary to allow collaborative authoring of documents. Thus, the collaborators have traditionally been required to use e-mail or other forms of communication to continuously notify/update each other of changes that have been or that need to be made to documents/code. That is, much of the burden of managing the collaboration on a Web project has been placed on the collaborators and has required the collaborators to keep each other updated as to their individual activities.

Hypertext Transfer Protocol (HTTP) is a well-known protocol that provides the set of rules for exchanging files (e.g., text, graphic images, sound, video, and other multimedia files) on the Web. HTTP alone does not natively support collaborative efforts. That is, HTTP does not natively enable clients to perfonn such management operations as locking a file, unlocking a file, retrieving properties of a file, etc., that are desirable in a collaborative environment.

In view of the above desire for managing collaborative efforts in the Web environment, a collaborative protocol known as “WebDAV” (World Wide Web Distributed Authoring and Versioning) has been developed recently. More particularly, WebDAV is the Internet Engineering Task Force (IETF) standard for collaborative authoring on the Web. WebDAV comprises a set of extensions to HTTP that facilitates collaborative editing and file management between users who may be located remotely from each other, on the Internet.

WebDAV is expected to have an impact on the development of virtual enterprises by enabling remote groups to work together in new ways. For example, WebDAV-conforming tools could be used by a virtual organization to develop business plans, create software, or write libraries of information. WebDAV is making advances toward early expectations of the Web's collaborative potential, by adding write access to the read access afforded by HTTP. Thus, WebDAV provides a protocol that enables collaborative access of documents in which a plurality of different users may access, update, revise, and/or otherwise modify the documents. In other words, WebDAV provides a standard infrastructure for asynchronous collaborative authoring of documents across the Internet (or other suitable communication network). In this manner, WebDAV makes the Web analogous to a large-grain, network-accessible file system.

WebDAV methods have been developed for performing operations desired for managing such a collaborative access of documents. For instance, WebDAV methods are known for performing such operations as: 1) locking digital assets or “resources” (also known as concurrency control), which prevents accidental overwriting of files; 2) setting, deleting, and retrieving properties of digital assets (using the DAV protocol); 3) performing searches based on property values for locating digital assets on the Web (using the DASL protocol); and 4) namespace manipulation, which supports copy and move operations. In view of the above, WebDAV provides a set of methods that can be used for managing collaborative access of digital assets, such as Web documents. More particularly, WebDAV methods may be used for managing digital assets in a manner that enables collaborative access of the digital assets by a plurality of different clients (e.g., developers, etc.).

Traditionally, the WebDAV protocol is used by clients to invoke WebDAV methods. Other communication protocols do not traditionally provide the above collaborative operations, such as locking/unlocking digital assets and setting, deleting, and retrieving properties of digital assets. Similarly, component technologies such as discussed below, traditionally do not provide such collaborative operations. That is component technologies such as Component Object Model (COM), Distributed Component Object Model (DCOM), or Enterprise Java Beams (EJB), as examples, do not natively include methods such as the above-described WebDAV methods for managing digital assets. Accordingly, if a client desires to use WebDAV methods for managing a digital asset (e.g., for collaborative access of the digital asset with other clients), the client is traditionally required to utilize the WebDAV protocol for invoking the desired WebDAV methods (e.g., to lock/unlock a file, retrieve file properties, etc.).

### SUMMARY

In accordance with one embodiment disclosed herein, a method for invoking a WebDAV method via a component technology is provided. The method comprises receiving a request for a WebDAV method in a component technology format, and responsive to receiving the request, invoking the requested WebDAV method.

In accordance with another embodiment disclosed herein, a system for invoking a WebDAV method via a protocol is provided. The system comprises a bridge receiving a request for a WebDAV method from a client via a component technology and enabling invocation of the WebDAV method, and a WebDAV processing unit invoking the requested WebDAV method.

In accordance with another embodiment disclosed herein, a bridge for enabling invocation of a WebDAV method via a component technology is provided. The bridge comprises a receiver operable to receive a request for a WebDAV method from a client via a component technology, an input handler operable to translate a received request from any of a plurality of different component technologies to a canonical format, and a request executor operable to translate a canonical formatted request to a WebDAV protocol request for invoking a requested WebDAV method.

In accordance with another embodiment disclosed herein, a computer program product comprises a computer usable medium having computer readable program code means embodied therein for invoking a WebDAV method via a component technology. The computer readable program code means in the computer program product comprises computer readable program code means for causing a computer to receive a request for a WebDAV method in a component technology format, and computer readable program code means responsive to receiving the request for causing the computer to invoke the requested WebDAV method.

### BRIEF DESCRIPTION OF THE DRAWINGS

FIG. 1 shows a system in which an example embodiment disclosed herein may be implemented;

FIG. 2 shows an example implementation of a bridge operable to receive a request for a WebDAV method via a component technology and invoke the desired WebDAV method; and

FIG. 3 shows an example operational flow diagram of the bridge of FIG. 2.

### DETAILED DESCRIPTION

As described above, WebDAV is a well-known collaborative protocol. WebDAV is generally described in the reference by E. James Whitehead, Jr., titled “World-Wide-Web Distributed Authoring and Versioning (WebDAV): An Introduction,” in Standard View, Vol. 5, No. 1, March 1997, pages 3-8, the disclosure of which is hereby incorporated herein by reference. The WebDAV specification is described further in IETF Request For Comments (RFC) 2518 titled “HTTP Extensions for Distributed Authoring” by Y. Goland, E. Whitehead, A. Faizi, S. Carter, and D. Jensen, the Internet Society (1999), a copy of which is available at http://www.ietf.org/rfc/rfc2518.txt?number=218, the disclosure of which is hereby incorporated herein by reference and referred to herein as RFC 2518. More specifically, RFC 2518 describes WebDAV as an extension to the HTTP/1.1 protocol that allows clients to perform remote web content authoring operations. This extension provides a coherent set of methods, headers, request entity body formats, and response entity body formats that provide operations for:

Properties: The ability to create, remove, and query information about Web pages, such as their authors, creation dates, etc. Also, the ability to link pages of any media type to related pages.

Collections: The ability to create sets of documents and to retrieve a hierarchical membership listing (like a directory listing in a file system).

Locking: The ability to keep more than one person from working on a document at the same time. This prevents the “lost update problem”, in which modifications are lost as first one author then another writes changes without merging the other author's changes.

Namespace Operations: The ability to instruct the server to copy and move Web resources.

As mentioned above, WebDAV methods have been developed for performing operations often desired in managing a collaborative access of digital assets. Such operations are not available in native HTTP. As examples, the following WebDAV methods have been developed:

1) LOCK method, which is used to take out a lock of any access type;

2) UNLOCK method, which removes the lock identified by the lock token in a Lock-Token request header from a Request-Uniform Resource Identified (URI);

3) PROPFIND method, which retrieves properties defined on the digital asset (or “resource”) identified by the Request-URI;

4) PROPATCH method, which processes instructions specified in the request body to set and/or remove properties defined on the digital asset (or “resource”) identified by the Request-URI;

5) MKCOL method, which may be used to create a new collection resource at the location specified by the Request-URI;

6) DELETE method, which deletes a digital asset (or “resource”) or collection of digital assets;

7) PUT method, which stores a digital asset to the supplied Request-URI;

8) COPY method, which creates a duplicate of the source resource identified by the Request-URI, in the destination resource identified by the URI in the destination header; and

9) MOVE method, which is the logical equivalent of the COPY method followed by consistency maintenance processing, followed by a delete of the source, where all three actions are performed automatically.

The above example WebDAV methods, as well as other known WebDAV methods, are described further in RFC 2518.

When working in a collaborative environment, WebDAV methods become desirable to utilize in order to manage the collaborative access of a digital asset. For instance, the issue of write control or locking is important in a collaborative environment. When two or more people can write to the same, unversioned document, changes can be lost as first one collaborator, then another makes changes without first merging in previous updates (the so-called “lost update problem”). WebDAV provides an exclusive write lock, which guarantees that only the lock owner can overwrite a locked resource, and a shared write lock, which allows a group of collaborators to work together on a resource. By supporting mechanisms for both shared and exclusive locking, WebDAV can accommodate a wide range of collaborations. In general, shared locks are desirable in environments in which collaborators are aware of each other's activities, and exclusive locks provide a higher degree of conflict avoidance for collaborators who are not in close contact. A lock discovery mechanism (a WebDAV “property” method) allows collaborators to find out if any locks exist on a Web resource. Because the Web is designed so that no lock is required to read a Web page, there is no concept of a read lock. An implication of this fact in a “writable” Web environment is that the contents of a digital asset may change without warning if a write lock is not owned on the digital asset.

As noted above component technologies are also known in the art. In object-oriented programming and distributed object technology, such as COM, DCOM and EJB, a component is a reusable program building block that can be combined with other components in the same or other computers in a distributed network to form an application. Examples of a component include: a single button in a graphical user interface, a small interest calculator, an interface to a database manager, etc. Generally, components can be deployed on different servers in a network and communicate with each other for needed services. A component typically runs within a context called a container. Examples of containers include pages on a Web site, Web browsers, and word processors.

As mentioned above, one component technology known in the existing art is Component Object Model (COM), which is Microsoft's framework for developing and supporting program component objects. It is aimed at providing similar capabilities to those defined in the Common Object Request Broker Architecture (CORBA), a framework for the interoperation of distributed objects in a network that is supported by other major companies in the computer industry. Whereas Microsoft's Object Linking and Embedding provides services for the compound document that users see on their display, COM provides the underlying services of interface negotiation, life cycle management (determining when an object can be removed from a system), licensing, and event services (putting one object into service as the result of an event that has happened to another object).

Another component technology known in the existing art is Distributed Component Object Model (DCOM). DCOM is a set of concepts and program interfaces in which client program objects can request services from server program objects on other computers in a network. DCOM is based on the COM technology described above, which provides a set of interfaces allowing clients and servers to communicate within the same computer (that is running Windows® 95 or a later version). For example, a user can create a page for a Web site that contains a script or program that can be processed (before being sent to a requesting user) not on the Web site server but on another, more specialized server in the network. Using DCOM interfaces, the Web server site program (now acting as a client object) can forward a Remote Procedure Call (RPC) to the specialized server object, which provides the necessary processing and returns the result to the Web server site. It passes the result on to the Web page viewer.

A very popular component technology of the existing art is Enterprise JavaBeans (EJB). EJB is an architecture for setting up program components, written in the Java programming language, that run in the server parts of a computer network that uses the client/server model. Enterprise JavaBeans is built on the JavaBeans technology for distributing program components (which are called Beans) to clients in a network. Enterprise JavaBeans offers enterprises the advantage of being able to control change at the server level rather than having to update each individual computer with a client whenever a new program component is changed or added. EJB components have the advantage of being reusable in multiple applications. To deploy an EJB Bean or component, it generally must be part of a specific application, which is called a container.

Originated by Sun Microsystems, Inc., EJB is somewhat similar to Microsoft's COM/DCOM architectures (described above), but, like all Java-based architectures, programs can be deployed across all major operating systems, not just Windows®. EJB's program components are generally known as servlets (small server programs). The application or container that runs the servlets is sometimes called an application server. A typical use of servlets is to replace Web programs that use the common gateway interface (CGI) and a Practical Extraction and Reporting Language script. Another general use is to provide an interface between Web users and a legacy application mainframe application and its database.

As described above, clients have traditionally been required to use the WebDAV protocol in order to take advantage of any one or more of the WebDAV methods for managing a digital asset (e.g., Web document). That is, if a client desires to use WebDAV methods, such as those identified above, the client has traditionally been required to use the WebDAV protocol for invoking such WebDAV methods. However, it is often desirable to manage a digital asset (or “resource”) using a WebDAV method without using the WebDAV protocol to do so. For instance, use of various communication protocols to invoke a WebDAV method for managing a digital asset is discussed in the co-owned copending, cofiled, patent applications incorporated by reference above. Further, as disclosed herein, a client may desire to utilize a component technology function, such as those described below. For instance, a client may desire to utilize a component technology function to request a WebDAV method for performing Properties, Collections, Locking, and/or Namespace operations, as examples, for managing a digital asset.

Both WebDAV methods and component technologies have become increasingly popular, and as their popularity continues to increase it becomes more desirable for clients to access WebDAV methods via non-WebDAV methods such as component technologies. That is, it is desirable to allow clients to access digital assets using WebDAV methods via different avenues (i.e., protocols and technologies other than WebDAV). For example, a client may desire to use non-collaborative component technologies (i.e., protocols and technologies that do not natively provide the operations of the WebDAV methods), such as COM, DCOM or EJBs, to send a message to a WebDAV server to request access to digital assets via WebDAV methods (i.e., to invoke one or more WebDAV methods for managing a digital asset). In many cases, a client may not want to use HTTP (with the WebDAV extension thereto) to access a digital asset. As an example, suppose a digital asset resides on the client's local computer in a WebDAV storage unit; the client may desire to use WebDAV methods to access the digital asset but would rather not use the HTTP protocol because that may result in performance degradation unnecessarily, or deny the client access to features or ease of use provided by component technologies. For example, a developer may be using J2EE® to build a web based application for accessing resources that are under the control of a WebDAV server. This example developer may not wish to programmatically interact with the WebDAV server on a HTTP level, but would rather use Enterprise Java Beans, which might be the current component model the developer is using to build the application, to access the resource. The present invention allows such a developer to interact with the WebDAV server as if it were a component technology element.

Embodiments disclosed herein provide systems and methods for enabling requests for WebDAV methods to be made via component technologies. In one embodiment, a “bridge” is provided that is capable of receiving a request that is not in the WebDAV protocol and is operable to invoke the requested WebDAV method for managing a digital asset. In this manner, clients may use component technologies to invoke WebDAV methods for managing digital assets. That is, clients are not restrained to using only the WebDAV protocol in order to take advantage of WebDAV methods for managing digital assets, but may instead use other protocols for requesting WebDAV methods to manage digital assets. Thus, the “bridge” provides a solution for enabling access to WebDAV methods via component technologies. That is, embodiments disclosed herein extend the WebDAV methods, such as those methods identified above, to non-WebDAV methods such as component technologies.

In certain embodiments, the bridge is operable to receive a request that is in any of a plurality of different non-WebDAV protocols. Such non-WebDAV protocols may, in certain implementations of the bridge, comprise component technologies, such as EJB, COM, and DCOM, as examples. In certain implementations, the bridge is capable of receiving a request for a WebDAV method via any of a plurality of different component technologies, such as EJB, COM, and DCOM. Further, in certain implementations, the bridge is capable of receiving a request for a WebDAV method via any of a plurality of different non-WebDAV protocols, wherein such plurality of different non-WebDAV protocols includes at least one non-WebDAV communication protocol such as File Transfer Protocol (FTP), Simple Mail Transfer Protocol (SMTP), and/or Simple Object Access Protocol (SOAP) and at least one component technology such as EJB, COM, and/or DCOM.

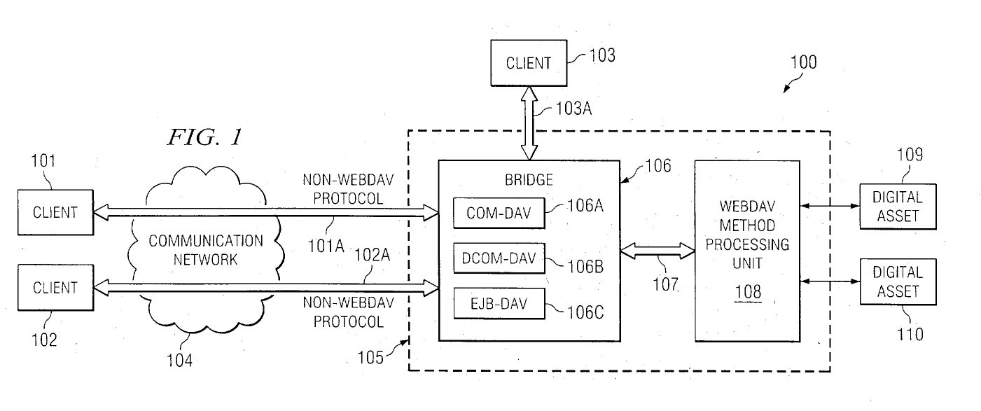

Turning to FIG. 1, a system of an example embodiment is shown. System 100 comprises one or more clients, such as clients 101 and 102, that are communicatively coupled to server 105 via communication network 104. Communication network 104 is preferably a packet-switched network, and in various implementations may comprise, as examples, the Internet or other Wide Area Network (WAN), an Intranet, Local Area Network (LAN), wireless network, Public (or private) Switched Telephony Network (PSTN), a combination of the above, or any other communications network now known or later developed within the networking arts that permits two or more computing devices to communicate with each other. Further, one or more clients, such as client 103 may be arranged local to server 105 and be communicatively coupled thereto.

In this example, server 105 comprises a WebDAV server that includes at least one WebDAV method processing unit 108. System 100 further comprises bridge 106, which is shown in this example as being implemented within server 105 but may in other embodiments be arranged external to server 105 and communicatively coupled thereto. System 100 further comprises digital assets, such as digital assets 109 and 110, that are accessible via WebDAV method processing unit 108. That is, WebDAV method processing unit 108 is operable to perform WebDAV methods on digital assets 109 and 110. Digital assets 109 and 110 may comprise any type of digitally stored information, such as documents (e.g., Web documents), for example. WebDAV servers implementing WebDAV method processing units, such as processing unit 108, are well known in the art. WebDAV method processing unit 108 may comprise any suitable implementation now known or later discovered for receiving a request for a WebDAV method to be invoked for a digital asset (digital assets 109 and/or 110) and process the request to perform the appropriate actions associated with the invoked WebDAV method (e.g., locking a digital asset, etc.).

Bridge 106 comprises interfaces that enable it to receive requests from clients 101-103 via a plurality of different non-WebDAV protocols. For instance, remote client 101 is communicatively coupled to bridge 106 via communication link 101A, and communicates a request for a WebDAV method to be invoked for one or more of digital assets 109 and 110 to bridge 106 over such communication link 101A via a non-WebDAV protocol such as a component technology. As described further below, bridge 106 is operable to receive the request and invoke the desired WebDAV method for one or more of digital assets 109 and 110 via link 107 and webDAV method processing unit 108. Bridge 106 is further operable to communicate responses from the WebDAV method to client 101 over communication link 101A via the component technology utilized by the client in requesting the WebDAV method. Similarly, remote client 102 may use a non-WebDAV component technology, or the like, to communicate requests for WebDAV methods to bridge 106 over communication link 102A, and bridge 106 may communicate responses from the invoked WebDAV method back to client 102 via the component technology used by client 102 in requesting the WebDAV method. Further, local client 103 may use a component technology to communicate requests for WebDAV methods to bridge 106 over communication link 103A, and bridge 106 may communicate responses from the invoked WebDAV method back to local client 103 via the component technology used by client 103 in requesting the WebDAV method. While three clients are shown in this example, it will be appreciated by those with ordinary skill in the art that any number of clients may be so included, and thus embodiments described herein are not limited solely to three clients.

In this example, bridge 106 comprises interfaces for receiving requests via COM, DCOM, and EJB. Bridge 106 comprises logic for interpreting a request received via a component technology for invoking a requested WebDAV method. In this example, bridge 106 comprises logic 106A for interpreting an COM request for invoking a WebDAV method requested thereby, logic 106B for interpreting a DCOM request for invoking a WebDAV method requested thereby, and logic 106C for interpreting a EJB request for invoking a WebDAV method requested thereby.

Bridge 106 provides seamless access to WebDAV methods via any of a plurality of different component technologies of which COM, DCOM and EJB are discussed and shown herein. Of course, clients may communicate with server 105 using the WebDAV protocol, if desired. That is, embodiments disclosed herein do not preclude use of the WebDAV protocol by clients for invoking WebDAV methods. Rather, requests for WebDAV methods via the WebDAV protocol may be communicated to server 105 (either via bridge 106 or directly to WebDAV method processing unit 108), and such requests may be processed by WebDAV method processing unit 108 in a manner as is well known in the art.

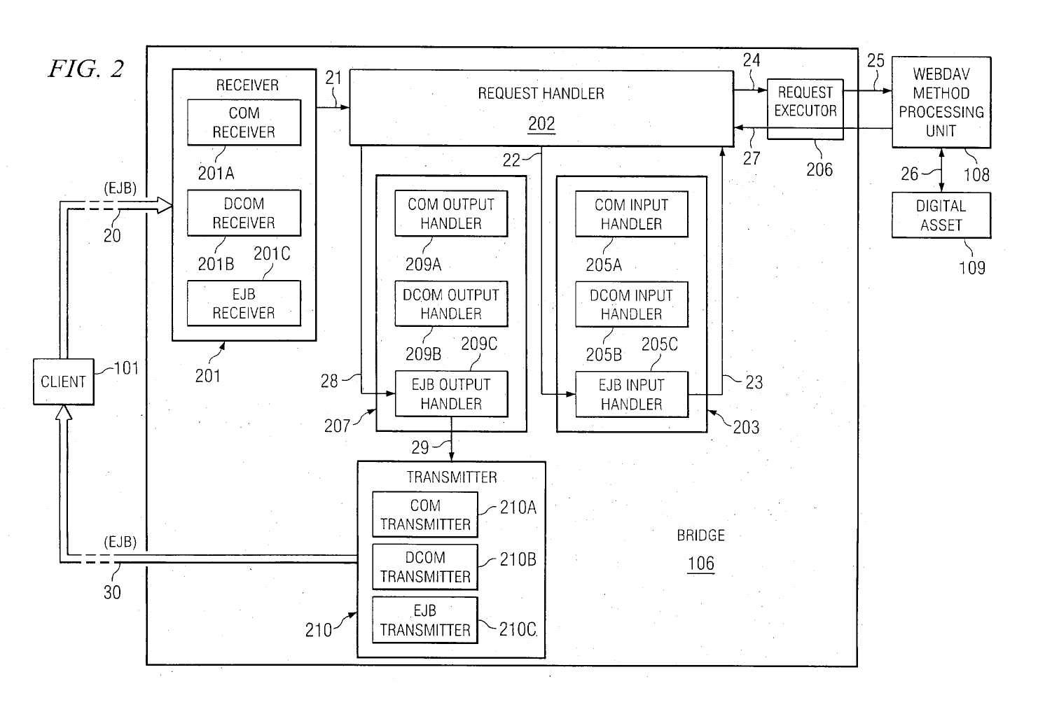

While any non-WebDAV protocol or component technology may be used in alternative embodiments, bridge 106 in the example of FIG. 1 enables invocation of WebDAV methods via any of the following component technologies: COM, DCOM, and EJB, each of which are well known in the art and are described briefly above. As described further hereafter in conjunction with FIG. 2, certain embodiments of bridge 106 enable invocation of WebDAV methods via component technologies that are not natively capable of invoking such WebDAV methods, such as the aforementioned COM, DCOM, and EJB.

Turning now to FIG. 2, an example implementation of bridge 106 is shown. As shown, bridge 106 may comprise a receiver 201, request handler 202, input handlers 203, request executor 206, output handlers 207, and transmitter 210. As discussed further below, in certain embodiments, input handlers 203 comprise at least one component technology handler, such as COM input handler 205A, DCOM input handler 205B, and/or EJB input handler 205C. Similarly, in certain embodiments, output handlers 207 comprise at least one component technology handler, such as COM output handler 209A, DCOM output handler 209B, and EJB output handler 209C. Although shown as separate modules in the example implementation of FIG. 2, it should be understood that in alternative implementations various ones of the modules 201-210 may be integrated together.

In operation, receiver 201 of bridge 106 is operable to receive a request from a client. More specifically, receiver 201 receives a request for invoking a WebDAV method for a digital asset, wherein such request utilizing a component technologies (e.g., the request). Receiver 201 comprises an interface suitable for receiving such a request from a client, such as client 101. For instance, in the example shown in FIG. 2, client 101 communicates request 20 via EJB to bridge 106. That is, request 20 is a EJB request to invoke a WebDAV method for digital asset 109 (e.g., to lock/unlock the digital asset, retrieve its properties, etc.). Receiver 201 receives the EJB request and sends it to request handler 202 via communication 21.

Receiver 201 may be implemented in a manner to support one or more component technologies (i.e., to receive a request for a WebDAV method via such component technologies). For instance, to support EJB, an EJB receiver 201C may be implemented in receiver 201 of bridge 106, and a J2EE® client application may communicate a request for invoking a WebDAV method to such EJB receiver 201C. COM receiver 201A and DCOM receiver 201B may be similarly implemented for receiving client requests for invoking WebDAV methods via those component technologies.

COM input handler 205A is implemented in bridge 106 in the example of FIG. 2 for receiving a request for a WebDAV method and translating the request into a canonical format that can be processed by request executor 206. Similarly, DCOM input handler 205B and EJB input handler 205C are each implemented in the example bridge 106 of FIG. 2. In an example embodiment, request handler 202 controls the request process. Receiver 201 is aware of the component technology format it receives from a client and communicates the received request to the request handler 202. Request handler 202 determines the proper input handler for handling the received request. As described further below, bridge 106 comprises input handlers that are operable to receive a request that uses a component technology and format the request into a canonical format. In certain implementations, multiple input handlers may be implemented for a given type of component technology (e.g., multiple input handlers for EJB, etc.). Further, while one receiver 201 is shown in the example of FIG. 2, multiple receivers 201 may be implemented in bridge 106. For instance, a different receiver may be implemented for each non-WebDAV component technology or communications protocol supported by bridge 106. For example, an EJB receiver may be implemented in bridge 106 for receiving EJB requests, and one or more EJB input handlers 205C may be implemented within bridge 106 for formatting a received EJB request into a canonical format, as described further below.

In the example shown in FIG. 2, request handler 202 determines an appropriate input handler for handling the received EJB request. That is, request handler 202 determines which of the plurality of different non-WebDAV component technologies (and communications protocol) input handlers 203 is suitable for handling the received request. More specifically, request handler 202 may determine an input handler 203 that is suitable for handling the received request based on the type of component technology of the request. The type of component technology (e.g., EJB, COM, DCOM, etc.) may be determined by request handler 202 based at least in part on the receiver 201 from which request handler 202 received the request. For instance, as mentioned above, a different receiver 201 may be implemented for each type of non-WebDAV component technology or communication protocol supported by bridge 106 in certain embodiments, and request handler 202 may therefore determine the type of non-WebDAV component technology or communication protocol of the request based at least in part on the receiver that received the request. For example, an EJB request may be received by an EJB receiver 201C and forwarded to request handler 202, which may determine (e.g., based on it receiving the request from EJB receiver 201C) that EJB input handler 205C is proper for handling the request. Accordingly, because the request in the example of FIG. 2 is in EJB, request handler 202 determines that EJB input handler 205C is the appropriate input handler for handling the received request. Accordingly, request handler 202 communicates the received request to EJB input handler 205C via communication 22.

The input handlers are operable to translate a request that uses a non-WebDAV component technology to a canonical format. That is, each of the input handlers 203 is operable to translate a request from a component technology format to a canonical format that request executor 206 is capable of processing. Examples of such a canonical format are described further below. Thus, in the specific example of FIG. 2, EJB input handler 205C translates the received EJB request to a canonical format, and then communicates the canonical formatted request back to request handler 202 via communication 23.

Then, request handler 202 determines that the request is for a WebDAV method and sends the canonical formatted request to request executor 206 via communication 24 for invocation of the requested WebDAV method. Request executor 206 maps the canonical formatted request to a WebDAV method. That is, request executor 206 translates the canonical formatted request into the WebDAV protocol for invoking the desired WebDAV method.

Request executor 206 then communicates the WebDAV request via communication 25 to WebDAV method processing unit 108. It should be recognized that in this example implementation, WebDAV method processing unit 108 need not have any special functionality for handling the request received from request executor 206. Rather, a request received from request executor 206 may be treated just like requests received from clients using the WebDAV protocol to invoke WebDAV methods. Request executor 206 may translate the canonical formatted request to a WebDAV request that WebDAV method processing unit 108 processes just as typical requests that it receives from clients using the WebDAV protocol. WebDAV method processing unit 108 performs the requested WebDAV method on digital asset 109, as illustrated by action 26.

Typically, a WebDAV method provides some type of response indicating whether the requested WebDAV method was successful in its action and/or otherwise providing information (e.g., requested properties about the digital asset) back to the client who invoked the WebDAV method. Thus, request handler 202 may receive such a response from WebDAV method processing unit 108 via communication 27 (which may be provided through request executor 206). Request handler 202 determines an appropriate output handler for handling the response to be output to the requesting client 101. That is, request handler 202 determines which of the plurality of different non-WebDAV component technology and communication protocol output handlers 207 that is suitable for handling the response from WebDAV method processing unit 108 to be output to the requesting client 101.

Any of various techniques may be utilized by request handler 202 for determining an appropriate output handler for a response in accordance with embodiments of bridge 106. As one example, request handler 202 may be implemented to know the original input handler 203 used for the request for which the response is received (i.e., request handler 202 may keep track of the component technology or communication protocol used by a requesting client and/or the input handler 203 used for the request), and request handler 202 may use this information to determine the appropriate output handler for translating the WebDAV response to the non-WebDAV component technology or communication protocol used by the requesting client in requesting the WebDAV method that generated the response. As another example, request handler 202 may be implemented to analyze the response from executor 206 and make the determination of the appropriate output handler to use based at least in part on information embedded in the response itself (e.g., the size of the response or level of service information within the response). In general, the request handler may be implemented to provide the capability of communicating a WebDAV response back either synchronously or asynchronously to the client that requested the WebDAV method.

COM output handler 209A is implemented for receiving a WebDAV response and translating the response to a non-WebDAV component technology format being used by the requesting client. Similarly, DCOM output handler 209B and EJB output handler 209C are each implemented in the example bridge 106 of FIG. 2. By way of example, because the request in the example of FIG. 2 was received from client 101 using EJBs, request handler 202 determines that EJB output handler 209C is the appropriate output handler for providing the response to client 101 for the invoked WebDAV method. Accordingly, request handler 202 communicates the received WebDAV method response to FTP output handler 209C via communication 28.

Output handlers 207 are operable to translate a WebDAV response that is in WebDAV format to a non-WebDAV component technology format. That is, each of output handlers 207 is operable to translate a response from the WebDAV protocol to a component technology format being used by the requesting client 101 for communication. In certain implementations, request executor 206 may be implemented to translate a received WebDAV response into a canonical format, and the output handlers 207 may be operable to translate the canonical formatted response to a non-WebDAV protocol used by the requesting client. In other implementations, the output handlers 207 are operable to receive a WebDAV response (that is not modified or reformatted in any way) and translate the WebDAV response to a component technology format. Thus, in the specific example of FIG. 2, EJB output handler 209C translates the WebDAV method response to an EJB format, and then communicates the EJB response to transmitter 210 via communication 29. Transmitter 210 then communicates the EJB response to client 101 via communication 30. Transmitter 210 may be implemented in bridge 106 in a manner to support one or more component technologies (i.e. to transmit a request for a WebDAV method via such component technologies). For instance, to support the EJB component technology, an EJB transmitter 210C may be implemented in bridge 106, and a WebDAV method reply to a J2EE® client application may be communicated by such EJB transmitter 210C. COM transmitter 210A and DCOM transmitter 210B may be similarly implemented for transmitting WebDAV methods responses via those component technologies.

Thus, FIG. 2 illustrates an example in which a client 101 uses a component technology (e.g., EJB) to invoke a WebDAV method and to receive a response (if any) generated from such a WebDAV method. Bridge 106 provides the translation operations necessary to enable a WebDAV method to be invoked by a request that utilizes a component technology. While communications between bridge 106 and client 101 utilize EJBs in the specific example shown in FIG. 2, it should be understood that the example bridge 106 shown in FIG. 2 enables communication with a client via any of a plurality of different component technologies, including COM, and DCOM in addition to EJB. Bridge 106 enables a WebDAV method to be invoked via any of these component technologies in a manner similar to that described above for EJB.

Example implementations that enable invocation of WebDAV methods via non-WebDAV protocols, according to which bridge 106 may be implemented in certain embodiments, are described in co-pending U.S. patent application Ser. No. [Attorney Docket No. 100203182-1], entitled “SYSTEM AND METHOD FOR INVOKING WEBDAV METHODS VIA NON-WEBDAV PROTOCOLS”, the disclosure of which is hereby incorporated herein by reference. Example of more specific implementations that enable invocation of WebDAV methods via non-WebDAV communication protocols, according to which bridge 106 may be implemented in certain embodiments, are described in co-pending U.S. patent application Ser. No. [Attorney Docket No. 100203180-1], entitled “SYSTEM AND METHOD FOR INVOKING WEBDAV METHODS VIA NON-WEBDAV COMMUNICATION PROTOCOLS”, the disclosures of which is hereby incorporated herein by reference.

The example implementation of bridge 106 in FIG. 2 is somewhat similar in its configuration to a Universal Listener Framework (ULF) proposed by Hewlett-Packard Company (HP) that enables translation of a plurality of different communication protocols to HTTP (for more information about such ULF proposed by HP, see the white paper titled “the universal listener framework™: a powerful, rapid-deployment request broker for mission critical communications enabled by Total-e-Server™” available at http://www.hpmiddleware.com/downloads/pdf/02-27-01 ULFWhitePaper.pdf, 2001, the disclosure of which is hereby incorporated herein by reference). However, rather than translating between any of a plurality of different protocols and HTTP, as in the ULF, the present systems and methods enables translation between any of a plurality of different protocols and WebDAV methods. For example, bridge 106 of FIG. 2 enables translation of any of a plurality of different non-WebDAV component technology formats directly into WebDAV for invoking WebDAV methods via such component technologies.

It should be recognized that the example embodiment of bridge 106 described in FIG. 2 is very flexible and scalable. For instance, bridge 106 can be easily adapted to support any combination of desired component technologies. More specifically, for a particular component technology, an input handler module that is capable of receiving a request in the particular non-WebDAV component technology format and translate it to the canonical format may be added to bridge 106. Further, an output handler module that is capable of receiving a WebDAV response and translate the response to the particular non-WebDAV component technology format may be added to bridge 106, and request handler 202 may be implemented to recognize the newly added input handler and output handler modules. In this implementation, request executor 206 need not be modified to support additional component technologies, as the input handler for an additional non-WebDAV protocol translates a request into a canonical format that is recognized by request executor 206. Further, WebDAV method processing unit 108 need not have its implementation modified, as bridge 106 provides the interpretations/translations necessary for enabling any of a plurality of different component technologies to invoke WebDAV methods.

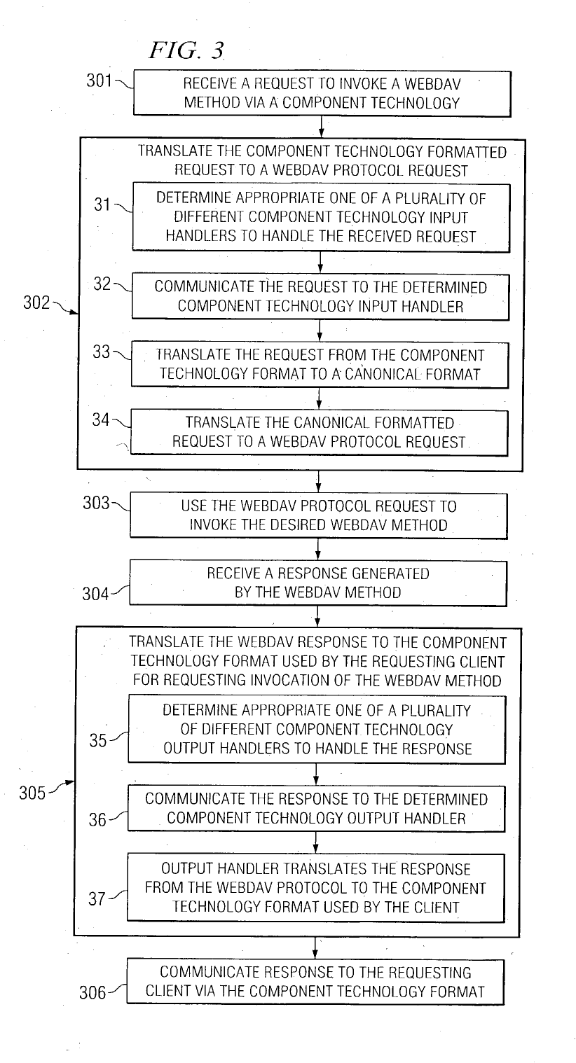

Turning to FIG. 3, an example operational flow diagram of one embodiment of a bridge 106 is shown. As shown, the bridge receives a request to invoke a WebDAV method via a non-WebDAV protocol in operational block 301. That is, in operational block 301 bridge 106 receives a request that is in a non-WebDAV component technology format (e.g., EJB request 20 in FIG. 2) that is not natively capable of invoking a WebDAV method. In operational block 302, bridge 106 translates the component technology request to a WebDAV protocol request. More specifically, in certain implementations such translation of block 302 may be performed in accordance with sub-blocks 31-34 shown in FIG. 3. Of course, in alternative implementations other techniques may be used for performing the translation of block 302. In the specific example shown in FIG. 3, bridge 106 determines an appropriate one of a plurality of different non-WebDAV input handlers 203 to handle the received request in sub-block 31. In sub-block 32, the received request is communicated to the determined appropriate non-WebDAV input handler. As noted above, determination 31 may be carried out by a general receiver, or by a receiver specific to a component technology, such as receivers 201A, 201B, or 201C of FIG. 2. In sub-block 33, the input handler translates the request from the non-WebDAV protocol to a canonical format. In sub-block 34, the canonical formatted request is processed to construct a WebDAV protocol request (i.e., a request for the desired WebDAV method in the WebDAV protocol). That is, the canonical formatted request is translated into a WebDAV protocol request in sub-block 34.

In operational block 303, the WebDAV protocol request is used to invoke the desired WebDAV method. Then, in operational block 304, a response generated by the invoked WebDAV method is received by the bridge. The bridge translates the WebDAV response to the non-WebDAV component technology format used by the requesting client for requesting invocation of the WebDAV method in operational block 305. More specifically, in certain implementations such translation of block 305 may be performed in accordance with sub-blocks 35-37 shown in FIG. 3. Of course, in alternative implementations other techniques may be used for performing the translation of block 305. In the specific example shown in FIG. 3, bridge 106 determines an appropriate one of a plurality of different non-WebDAV output handlers 207 to handle the received response in sub-block 35. In sub-block 36, the received WebDAV response is communicated to the determined appropriate non-WebDAV output handler. In sub-block 37, the output handler translates the response from the WebDAV protocol to a non-WebDAV component teclmology format protocol (e.g., the component technology format protocol used by the client in invoking the WebDAV method). In operational block 306, bridge 106 communicates the response to the requesting client via the non-WebDAV protocol. As noted above, communication 301 may be carried out by a general transmitter or by a transmitter specific to a component technology, such as transmitters 210A, 210B, or 210C of FIG. 2.

As described above, in certain embodiments of bridge 106, input handlers 203 are operable to translate a component technology request to a canonical format. Various techniques exist for translating a received request into a canonical format. In certain implementations, the input handlers 203 retrieve information that is included within the request itself and organizes the information into a canonical format that can be processed by request executor 206. For example, the canonical format may comprise a table in certain implementations. An example table structure is shown as Table 1 below.

TABLE 1

| | |
|---|---|
| Requested WebDAV Method: | Lock |
| Digital Asset: | Digital Asset 109 |
| Requesting Client: | Client 101 |
| Format of Request: | EJB |

In the example of Table 1, the first column of the table identifies various information that may be obtained for a received request, such as the requested WebDAV method(s), the digital asset(s) for which the method is requested, the requesting client, and the format of the request. The second column of the table provides values corresponding to each of the fields of information of the first column. For instance, in the example of Table 1, the requested WebDAV method is identified as the Lock method. The digital asset for which the method is requested is identified as “Digital Asset 109” (which is consistent with the example of FIG. 2 and which may actually include a file name or other suitable identification of the digital asset). The requesting client is identified as “Client 101” (which is consistent with the example of FIG. 2 and may actually include a client's IP address or other suitable identification of the requesting client). The format of the request is EJB (which is consistent with the example of FIG. 2).

Again, the information of Table 1 may be populated by the input handler processing a received request. Such input handler may analyze the received request (e.g., the body of the request) and retrieve the information for the fields of Table 1 from such request. Certain rules may be imposed on clients regarding how certain information, such as identification of the WebDAV method to be invoked and identification of the digital asset for which the WebDAV method is to be invoked, is to be arranged within a request to enable an input handler to better identify such information from the request.

The present systems and methods provides an ability to create a method name in the receiver. The receiver passes that information (through the request handler) to an input handler. The input handler translates the component technology request in a canonical format. The component technology formatted request provides a specific method with parameters and method name that input handler can then massage out to a request executor. As an example of translating a request for a WebDAV method from a component technology format to a canonical format, such as that of Table 1 above, suppose a request for a WebDAV method is received at the bridge as an method invocation on the receiver EJB. In one implementation, the received method could, by way of example, be public void lock for DigitalAsset(uniqueID). The EJB input handler would analyze the request and employ, by way of example, the parameters of the argument and the method name, thus converting the component technology formatted request into a canonical format, such as a table of information, for use by the request executor.

One of ordinary skill in the art will appreciate that various techniques may be used for including information for invoking a WebDAV method within a request that is communicated to bridge 106 via a component technology, and input handlers 203 may then analyze the received request to determine such infonnation and construct it into a canonical format (such as a table) that can be used by request executor 206 for invoking the desired WebDAV method. While a table is shown in the example above, it should be understood that other canonical fonnats may be used in alternative embodiments. Preferably, the same canonical format is used for each of the plurality of different non-WebDAV component technologies or protocols. That is, preferably, each of the plurality of non-WebDAV input handlers construct their requests into a common canonical format, such that request executor 206 receives substantially the same canonical fonnatted request irrespective of whether the request originated from a client using EJBs, a client using FTP, or a client using some other non-WebDAV component technology or protocol.

What is claimed is:

1. A method for invoking a WebDAV method via a component technology comprising:
receiving a request for a WebDAV method in a component technology format; and
responsive to receiving said request, invoking the requested WebDAV method.

2. The method of claim 1 further comprising:
translating the received request to a WebDAV protocol.

3. The method of claim 2 wherein said invoking comprises:
communicating the translated request via said WebDAV protocol to a WebDAV method processing unit.

4. The method of claim 1 further comprising:
translating the received request to a canonical format.

5. The method of claim 4 further comprising:
translating the canonical formatted request to a WebDAV protocol.

6. The method of claim 1 wherein said receiving comprises:
receiving said request in any one fomiat of a plurality of different component technology formats.

7. The method of claim 6 further comprising:
determining to which of a plurality of different input handlers to communicate the received request;
communicating the received request to a determined one of said plurality of different input handlers; and
translating said received request to a canonical format using said determined one of said plurality of different input handlers.

8. The method of claim 7 further comprising:
communicating said canonical fonnatted request to a request executor; and
translating, by said request executor, said canonical formatted request to a WebDAV protocol and communicating the request via said WebDAV protocol to a WebDAV method processing unit.

9. The method of claim 6 wherein said plurality of different component technologies comprises at least one selected from the group consisting of:
Enterprise Java Beans (EJB), Component Object Model (COM), and Distributed Component Object Model (DCOM).

10. The method of claim 1 further comprising:
outputting a WebDAV response in a component technology format to a requester that originated said request.

11. A system for invoking a WebDAV method via a component technology, the system comprising:
a bridge receiving a request for a WebDAV method from a client via a component technology and enabling invocation of said WebDAV method; and
a WebDAV processing unit invoking the requested WebDAV method.

12. The system of claim 11 wherein said bridge is adapted to receive a request via any of a plurality of different component technologies.

13. The system of claim 11 wherein said bridge further comprises an input handler for translating a received request from a component technology format to a WebDAV protocol.

14. The system of claim 11 wherein said bridge further comprises a plurality of input handlers, each translating a received request from a particular component technology to a canonical format.

15. The system of claim 14 further comprising:
a receiver determining which of said plurality of input handlers to communicate a received request.

16. The system of claim 14 further comprising:
a request executor translating a canonical formatted request to a WebDAV protocol request.

17. The system of claim 11 wherein said bridge comprises a plurality of receivers, each of said plurality of receivers operable to receive a request for a WebDAV method from a client via a different component technology.

18. The system of claim 11 wherein said bridge further comprises an output handler for translating a response to a requester from a WebDAV protocol into a component technology format.

19. The bridge of claim 18 wherein said bridge further comprises a plurality of transmitters, each of said plurality of transmitters operable to transmit a WebDAV method response to a client via a different component technology.

20. A bridge for enabling invocation of a WebDAV method via a component technology, said bridge comprising:
a receiver operable to receive a request for a WebDAV method from a client via a component technology;
an input handler operable to translate a received request from any of a plurality of different component technologies to a canonical format; and
a request executor operable to translate a canonical formatted request to a WebDAV protocol request for invoking a requested WebDAV method.

21. The bridge of claim 20 wherein said plurality of different -component technologies comprises at least one selected from the group consisting of:
Enterprise Java Beans (EJB), Component Object Model (COM), and Distributed Component Object Model (DCOM).

22. The bridge of claim 20 wherein said bridge comprises a plurality of receivers, each of said plurality of receivers operable to receive a request for a WebDAV method from a client via a different component technology.

23. The bridge of claim 20 further comprising an output handler for translating a response to a requester from a WebDAV protocol into a component technology format.

24. The bridge of claim 23 wherein said bridge comprises a plurality of transmitters, each of said plurality of transmitters operable to transmit a WebDAV method response to a client via a different component technology.

25. A computer program product comprising:
a computer usable medium having computer readable program code means embodied therein for invoking a WebDAV method via a component technology, the computer readable program code means in said computer program product comprising:
computer readable program code means for causing a computer to receive a request for a WebDAV method in a component technology format; and
computer readable program code means responsive to receiving said request for causing the computer to invoke the requested WebDAV method.

26. The computer program product of claim 25 further comprising:
computer readable program code means for causing a computer to translate the received request to a WebDAV protocol.

27. The computer program product of claim 26 wherein said invoking comprises:
computer readable program code means for causing a computer to communicate the translated request via said WebDAV protocol to a WebDAV method processing unit.

28. The computer program product of claim 25 further comprising:
computer readable program code means for causing a computer to translate the received request into a canonical format.

29. The computer program product of claim 28 further comprising:
computer readable program code means for causing a computer to translate the canonical formatted request to a WebDAV protocol.

30. The computer program product of claim 25 wherein said receiving comprises:
computer readable program code means for causing a computer to receive said request in any one format of a plurality of different component technology formats.

31. The computer program product of claim 30 further comprising:
computer readable program code means for causing a computer to determine to which of a plurality of different input handlers to communicate the received request;
computer readable program code means for causing a computer to communicate the received request to a determined one of said plurality of different input handlers; and
computer readable program code means for causing a computer to translate said received request to a canonical format using said determined one of said plurality of different input handlers.

32. The computer program product of claim 31 further comprising:
computer readable program code means for causing a computer to communicate said canonical formatted request to a request executor;
computer readable program code means for causing said request executor to translate said canonical formatted request to a WebDAV protocol; and
computer readable program code means for causing said request executor to communicate the request via said WebDAV protocol to a WebDAV method processing unit.

33. The computer program product of claim 30 wherein said plurality of different component technologies comprises at least one selected from the group consisting of:
Enterprise Java Beans (EJB), Component Object Model (COM), and Distributed Component Object Model (DCOM).

34. The computer program product of claim 25 further comprising:
computer readable program code means for causing a computer to output a WebDAV response in a component technology format to a requester that originated said request.
